(19) United States
(12) Patent Application Publication
(10) Pub. No.: US 2017/0155957 A1
(43) Pub. Date: Jun. 1, 2017

(54) METHOD AND DEVICE FOR CONTROLLING ACCESS TO INTERACTION FUNCTIONS OF SMART TV

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventors: Min WANG, Tianjin (CN); Jia YU, Tianjin (CN)

(21) Appl. No.: 15/245,056

(22) Filed: Aug. 23, 2016

Related U.S. Application Data
(63) Continuation of application No. PCT/CN2016/089115, filed on Jul. 7, 2016.

(30) Foreign Application Priority Data
Nov. 30, 2015 (CN) 201510862321.7

(51) Int. Cl. H04N 21/442; H04N 21/436; H04N 21/6332

(52) U.S. Cl. CPC H04N 21/44231; H04N 21/6332; H04N 21/43607

(57) ABSTRACT

An embodiment of the present disclosure discloses a method and a device for controlling access to interaction functions of a smart TV. The method comprises steps of: receiving a command for starting a card list, wherein the card list comprises a plurality of cards and every card has corresponding interaction functions; acquiring at least one card from a server; selecting at least one card needed to be shown from the required at least one card; acquiring show information of at least one card needed to be shown, wherein the show information comprises an access to the card; and showing the show information of the at least one card needed to be shown in the card list. According to the operation strategies of the server and the current program module the card list belongs, the present disclosure configures the card show information (including the access to the card) in real time, thus greatly improving user experience.

### CROSS-REFERENCE TO RELATED APPLICATIONS

The present disclosure is a continuation of International Application No. PCT/CN2016/089115, filed on Jul. 7, 2016, which is based upon and claims priority to Chinese Patent Application No. 201510862321.7, entitled “METHOD AND DEVICE FOR CONTROLLING ACCESS TO INTERACTION FUNCTIONS OF SMART TV”, filed on Nov. 30, 2015, the entire contents of which are incorporated herein by reference.

### TECHNICAL FIELD

The disclosure generally relates to the technical field of household appliances, in particular to a method and a device for controlling access to interaction functions of a smart TV.

### BACKGROUND

The emergence of smart TVs greatly improves large-screen watching experience, and smart TVs become the center of household entertainments. The smart TV may integrate network resources, provide more functions and services specially designed for watching TV programs, for example related information about programs, introduction to related stars, related video, etc., thus improving user's watching experience.

At present, a TV interaction platform is a platform for providing strengthened program services on the basis of video programs. The TV interaction platform may provide a uniform program content interaction function for cabled TV programs, carousel programs and request programs. Due to a large number of interaction functions, different modules (for example, cabled TV module, carousel module and request module) need different interaction functions, and the interaction function is highly real-time, so interaction function for hot spots is needed to be brought on line quickly. In the prior art, according to a first solution, the interaction functions of a TV UI (User Interface) are written to the system, along with the release of a version. However, the cycle of version release is relatively longer (about 1 month), so it fails to bring the function on line or off line by operation strategies. According to a second solution, the interaction functions are written into a client in a hard-coded way, also failing to flexibly configure the appearance time of the interaction function access by the operation strategies, and when some interaction functions change, it fails to make corrections in time.

In conclusion, TV programs in the prior art have more demands on the timeliness and flexibility of the interaction functions, and different interaction functions are needed to be shown in different channels, in different programs and at different time. However, the solutions in the prior art fail to meet the requirement for flexibly configuring the interaction function access by operation strategies, and when new interaction contents appear, how the interaction functions show the new interaction contents is also a problem.

### SUMMARY

An embodiment of the present disclosure discloses a method and a device for controlling access to interaction functions of a smart TV to solve the problem that the prior art fail to meet the requirement for flexibly configuring the interaction function access by operation strategies and overcome the defect that the interaction functions fail to quickly show new interaction contents when the new interaction contents appear, thus quickly bringing new interaction functions on line and improving user experience.

According to one aspect of the present disclosure, an embodiment of the present disclosure discloses a method for controlling access to interaction functions of a smart TV, including the following steps of: receiving a command for starting a card list, wherein the card list includes a plurality of cards and every card has corresponding interaction functions; acquiring at least one card from a server; selecting at least one card needed to be shown from the needed at least one card; acquiring show information of at least one card needed to be shown, wherein the show information includes an access to the card; and showing the show information of the at least one card needed to be shown in the card list.

According to another aspect of the present disclosure, an embodiment of the present disclosure discloses an electronic device for controlling access to interaction functions, including: at least one processor; and a memory communicably connected with the at least one processor for storing instructions executable by the at least one processor, wherein execution of the instructions by the at least one processor causes the at least one processor to: receive a command for starting a card list, wherein the card list includes a plurality of cards and every card has corresponding interaction functions; acquire at least one card from a server; select at least one card needed to be shown from the required at least one card; acquire show information of at least one card needed to be shown, wherein the show information includes an access to the card; and a show module for showing the show information of the at least one card needed to be shown in the card list.

According to another aspect of the present disclosure, an embodiment of the present discloses a computer program, including computer readable codes, wherein the computer readable codes operate on a smart TV such that the smart TV executes the method for controlling the access to the interaction functions of the smart TV.

According to another aspect of the present disclosure, an embodiment of the present discloses a non-transitory computer readable medium storing executable instructions that, when executed by an electronic device, cause the electronic device to:
receive a command for starting a card list, wherein the card list includes a plurality of cards, and each card has corresponding interaction functions;
acquire required at least one card from a server;
select at least one card needed to be shown from the required at least one card;
acquire the show information of the at least one card needed to be shown, wherein the show information includes the access to the card; and
show the show information of the at least one card needed to be shown in the card list.

The present disclosure has the following beneficial effects:
an embodiment of the present disclosure discloses a method and a device for controlling access to interaction functions of a smart TV After a command for starting a card list is received, required at least one card is acquired from a server wherein the required at least one card includes new interaction contents issued by the server according to operation strategies; then, at least one card needed to be shown is selected from the required at least one card, for example, at least one card needed to be shown is selected from the required at least one card according to the authority to each card, and after the show information (including access to the card) of the at least one card needed to be shown is acquired, the show information of the at least one card needed to be shown is shown in the card list. Therefore, the card show information (including the access to the card) may be flexibly configured in real time according to the operation strategies of the server, and new interaction contents may be quickly brought on line, thus greatly improving user experience.

The above description is a summary of the solution of the present disclosure. In order to more clearly describe the technical means of the present disclosure, the content of the description may be executed. Moreover, in order to ensure that the above and other objectives, characteristics and advantages of the present disclosure more understandable, embodiments of the present disclosure are described below.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flowchart of a method for controlling access to interaction functions of a smart TV according to an embodiment of the present disclosure.

FIG. 2 is a step flowchart of another method for controlling access to interaction functions of a smart TV according to an embodiment of the present disclosure.

FIG. 3 is a schematic view of call-out of a card list according to a method for controlling access to interaction functions of a smart TV according to an embodiment of the present disclosure.

FIG. 4 is a step flowchart of card startup of a method for controlling access to interaction functions of a smart TV according to an embodiment of the present disclosure.

FIG. 5 is a structural block diagram of a device for controlling access to interaction functions of a smart TV according to an embodiment of the present disclosure.

FIG. 6 is a structural block diagram of another device for controlling access to interaction functions of a smart TV according to an embodiment of the present disclosure.

FIG. 7 schematically illustrates a block diagram of an electronic device for executing the steps of the method according to the present disclosure.

FIG. 8 schematically illustrates a storage unit for holding or carrying program codes for realizing the steps of the method according to the present disclosure.

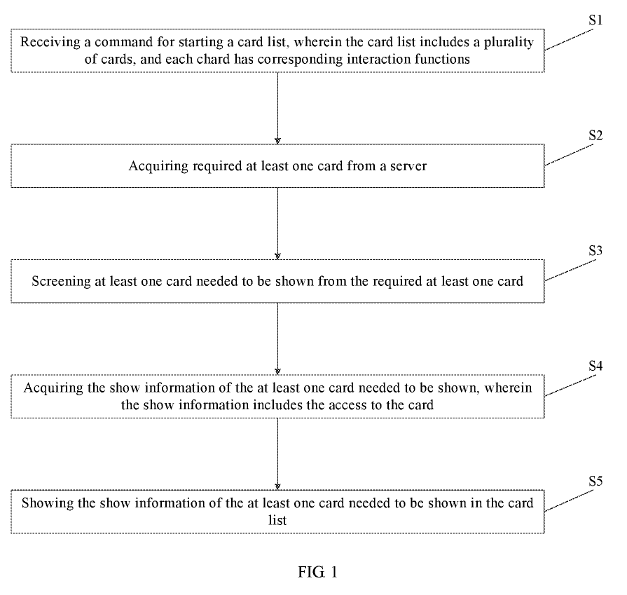

### DETAILED DESCRIPTION

To make the objectives, technical solutions and advantage of the embodiments of the present disclosure more clear, the technical solutions in embodiments of the present disclosure are clearly and completely described below with reference to drawings in the embodiments of the present disclosure. Obviously, the described embodiments are some embodiments of the present disclosure, not all the embodiments of the present disclosure. Based on the embodiments in the present disclosure, those ordinarily skilled in this field may obtain other embodiments without creative labor, which all shall fall within the protection scope of the present disclosure.

### Embodiment 1

Refer to FIG., which is a step flowchart of a method for controlling access to interaction functions of a smart TV according to an embodiment of the present disclosure.

The method for controlling access to interaction functions of a smart TV according to this embodiment of the present disclosure includes the following steps.

S1: Receive a command for starting a card list, wherein the card list includes a plurality of cards, and each card has corresponding interaction functions.

Specifically, according one embodiment of the present disclosure, the card is a plugin/APK (Android Package); the card list is a card APK, and the card APK may be configured as an access to the interaction functions of the card. It should be noted that the card list may be a card APK of a standard program which conforms to the Android specifications; the main Activity (component) of the card list inherits from DLBasePluginActivity (base class of the plugin Activity in the Android dynamic loading framework, used for encapsulating agent operation), and the DLBasePluginActivity itself is implemented on the basis of the main Activity of the Android standard application, wherein the main Activity of the card list is agented by the Android dynamic loading framework during operation, while the Android dynamic loading framework may start the card through the main Activity of the card list. Meanwhile, the main Activity of the card list uses the key word “that” when citing resources, instead of the key word “this” as specified by Android. Besides, like the main Activity of the Android standard application, the main Activity of the card list is also a main interface or main window of an application, so the main Activity of the card list may interact with a user.

S2: Acquire required at least one card from a server.

According to one embodiment of the present disclosure, the required at least one card may include at least one new on-line card, and/or at least one off-line card, and/or at least one card to be updated. This means that, the required at least one card may include at least one new on-line card, or at least one off-line card, or at least one card to be updated, or at least one new on-line card and at least one off-line card, or at least one new on-line card and at least one card to be updated, or at least one off-line card and at least one card to be updated, or at least one new on-line card, at least one off-line card and at least one card to be updated. Therefore, interaction contents with changes relative to the versions of the interaction functions in a smart TV may be acquired from the server.

Specifically, the server in Step S2 may provide the smart TV with an interaction platform server with interaction functions. When the card list is started, the smart TV opens a background Thread to acquire the required card list from the server and APK documents of each card in the required card list, and stores the required card list and the APK documents of each card in the required card list into a local folder and/or a local database sqlite (light database) of the smart TV for later use, for example use when the card list is started later. Optionally, when the required at least one card includes at least one off-line card, the Thread may acquire at least one off-line card list only from the server, and stores the at least one off-line card list into the local folder and/or the local database sqlite of the smart TV for later use.

S3: Select at least one card needed to be shown from the required at least one card.

Wherein, according to one embodiment of the present disclosure, the server may configure the authority to new interaction contents, namely the card authority, according to the operation strategies, so each card in the required at least one card has respective authority and therefore at least one card needed to be shown may be selected according to the respective authority of each card.

S4: Acquire the show information of the at least one card needed to be shown, wherein the show information includes the access to the card.

Wherein, according to one embodiment of the present disclosure, the at least one card needed to be shown may include self-defined cards and/or at least one third-party card. Wherein the self-defined cards are self-defined cards of the server, and the third-party card is a card supplied by other interaction platform server. Therefore, the card list may show richer interaction contents.

Optionally, according to one embodiment of the present disclosure, when the card needed to be shown is a self-defined card, acquisition of the show information of the card may be acquisition of the access (including an access icon) and card name, etc. of the card; when the card needed to be shown in a third-party card, acquisition of the show information of the card may be acquisition of the card access (including the access icon), card name, card's URL (Uniform Resource Locator) address, etc. Wherein the card's URL address may be written at a specific position in the APK document of the card for being read by the card list.

Specifically, after the APK documents of each card (the APK documents of off-line card excluded) in the required card list are acquired in step S2, in step S4, the APK documents of each self-defined card may be analyzed, and the card access, card name, etc. may be acquired through the PackageManager class of Android (for encapsulation of all data structures based on loading information), while for the third-party card, the show information (access icon, etc.) of the third-party card may be put into the card list in advance. By this time, in step S4, the show information of the third-party card may be directly acquired from the card list, without analyzing the APK documents of the third-party card.

It is needed to note that, the access icons of the self-defined cards and the third-party cards may all be visually designed by the server, and packaged and stored in the corresponding APK documents after design. After the required at least one card is acquired from the server, for the self-defined cards, the access icons thereof may be taken out through analyzing the APK documents of the self-defined cards; and for the third-party cards, the access icons thereof may be directly taken out.

S5: Show the show information of the at least one card needed to be shown in the card list.

It is needed to noted that, the card list may include the access to at least one resident card; the resident card may be any one of a program detail card, a star card, a relevant video card and a microblog card, and the program detail card, the star card, the relevant video card and the microblog card are self-defined cards. Wherein, among the self-defined cards, the program detail card, the star card and the relevant video card are installed in the smart TV by default; the background of the smart TV also deems that the program detail card, star card and the relevant video card are in on-line state by default; and in the TV version with the microblog, the access to the microblog card is written in the card list by default. Therefore, the access icons of the program detail card, the star card, the relevant video card and the microblog card certainly appear when the card list is called out, while the access icons of other cards are shown in a dynamic way.

Specifically, according to one embodiment of the present disclosure, the card list is a horizontal list. The horizontal list may be achieved by the component HorizontalListView. The component HorizontalListView is an AdapterView class integrated self-defined component, basically capable of achieving the effect as the same as that of the original Android ListView component, and only different in that the effect of the component of HorizontalListView is a horizontal effect. Wherein the UI (User Interface) of the horizontal list may be shown on the basis of the main Activity of the card list, so the user may operate the card through the card list.

Further, according to one embodiment of the present disclosure, in the process of starting the card list, if at least one new card is an on-line card and/or card to be updated relative to the version of the interaction functions in the smart TV when the server has at least one new card which has passed according to the operation strategies but does not complete installation, then the show information of the at least one new card is not shown after current startup of the card list, but shown after the next startup of the card list.

According to the first embodiment of the present disclosure, after a command for starting a card list is received, the required at least one card is acquired from a server wherein the required at least one card includes new interaction contents issued by the server according to operation strategies; then, at least one card needed to be shown is selected from the required at least one card, for example, at least one card needed to be shown is selected from the required at least one card according to the authority to each card, and after the show information (including access to the card) of the at least one card needed to be shown is acquired, the show information of the at least one card needed to be shown is shown in the card list. Therefore, the card show information (including the access to the card) may be flexibly configured in real time according to the operation strategies of the server, and new interaction contents may be quickly brought on line, thus greatly improving user experience.

### Embodiment 2

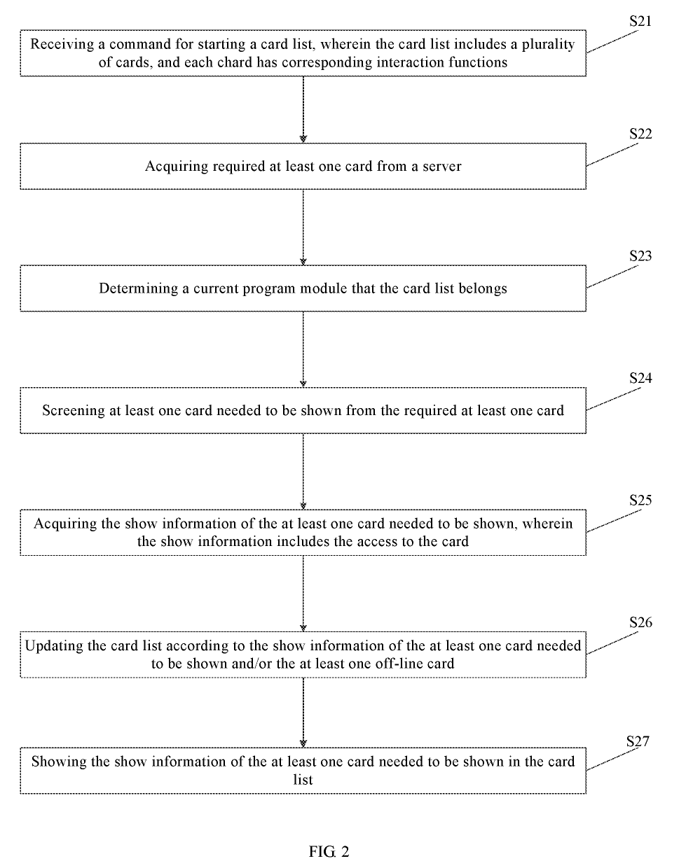

Refer to FIG. 2, which is a step flowchart of another method for controlling access to interaction functions of a smart TV according to an embodiment of the present disclosure. The method for controlling access to interaction functions of a smart TV includes the following steps.

S21: Receive a command for starting a card list, wherein the card list includes a plurality of cards, and each card has corresponding interaction functions.

Specifically, according one embodiment of the present disclosure, the card is a plugin/APK; the card list is a card APK, and the card APK may be configured as an access to the interaction functions of the card. It should be noted that, the card list may be a card APK of a standard program which conforms to the Android specifications; the main Activity of the card list inherits from DLBasePluginActivity, and the DLBasePluginActivity itself is implemented on the basis of the main Activity of the Android standard application, wherein the main Activity of the card list is agented by the Android dynamic loading framework during operation, while the Android dynamic loading framework may start the card through the main Activity of the card list. Meanwhile, the main Activity of the card list uses the key word “that” when citing resources, instead of the key word “this” as specified by Android. Besides, like the main Activity of the Android standard application, the main Activity of the card list is also a main interface or main window of an application, so the main Activity of the card list may interact with a user.

S22: Acquire required at least one card from a server.

According to one embodiment of the present disclosure, the required at least one card may include at least one new on-line card, and/or at least one off-line card, and/or at least one card to be updated. This means that, the required at least one card may include at least one new on-line card, or at least one off-line card, or at least one card to be updated, or at least one new on-line card and at least one off-line card, or at least one new on-line card and at least one card to be updated, or at least one off-line card and at least one card to be updated, or at least one new on-line card, at least one off-line card and at least one card to be updated. Therefore, interaction contents with changes relative to the versions of the interaction functions in a smart TV may be acquired from the server.

Specifically, the server in Step S22 may provide the smart TV with an interaction platform server with interaction functions. When the card list is started, the smart TV opens a background Thread to acquire the required card list from the server and APK documents of each card in the required card list, and stores the required card list and the APK documents of each card in the required card list into a local folder and/or a local database sqlite of the smart TV for later use, for example use when the card list is started later. Optionally, when the required at least one card includes at least one off-line card, the Thread may acquire at least one off-line card list only from the server, and stores the at least one off-line card list into the local folder and/or the local database sqlite of the smart TV for later use.

S23: Determine a current program module that the card list belongs.

It should be noted that, Step S23 may be executed between Step S21 and Step S22.

The current program module in Step S23 may be any one of a cabled TV module, a carousel module and a request module.

Further, according to one embodiment of the present disclosure, the current program (including the title of the current program) that the card list belongs may be determined when the current program module that the card list belongs is determined.

S24: Select at least one card needed to be shown from the required at least one card.

Wherein, according to one embodiment of the present disclosure, the server may configure the authority to new interaction contents, namely the card authority, according to the operation strategies, so each card in the required at least one card has respective authority and therefore at least one card needed to be shown may be selected according to the respective authority of each card.

For example, the server may be configured with different cards for different modules according to the operation strategies. It should be noted that, a card may apply to a plurality of modules.

Optionally, according to one embodiment of the present disclosure, the at least one card needed to be shown may be at least one card, with the authority applicable to the current program module, among the at least one new on-line card and/or at least one card to be updated. Therefore, the card list may quickly show new card contents in time.

S25: Acquire the show information of the at least one card needed to be shown, wherein the show information includes the access to the card.

Wherein, according to one embodiment of the present disclosure, the at least one card needed to be shown may include self-defined cards and/or at least one third-party card. Wherein the self-defined cards are self-defined cards of the server, and the third-party card is a card supplied by other interaction platform server. Therefore, the card list may show richer interaction contents.

Optionally, according to one embodiment of the present disclosure, when the card needed to be shown in a self-defined card, acquisition of the show information of the card may be acquisition of the access (including an access icon) and card name, etc. of the card; when the card needed to be shown in a third-party card, acquisition of the show information of the card may be acquisition of the card access (including the access icon), card name, card's URL address, etc. Wherein the card's URL address may be written at a specific position in the APK document of the card for being read by the card list.

Specifically, after the APK documents of each card (the APK documents of off-line card excluded) in the required card list are acquired in step S22, in step S25, the APK documents of each self-defined card may be analyzed, and the card access, card name, etc. may be acquired through the PackageManager class of Android, while for the third-party card, the shown information (access icon, etc.) of the third-party card may be put into the card list in advance. By this time, in step S25, the show information of the third-party card may be directly acquired from the card list, without analyzing the APK documents of the third-party card.

It is needed to note that, the access icons of the self-defined cards and the third-party cards may all be visually designed by the server, and packaged and stored in the corresponding APK documents after design. After the required at least one card is acquired from the server, for the self-defined cards, the access icons thereof may be taken out through analyzing the APK documents of the self-defined cards; and for the third-party cards, the access icons thereof may be directly taken out.

S26: Update the card list according to the show information of the at least one card needed to be shown and/or the at least one off-line card.

Wherein, the show information of the on-line card among the at least one card needed to be shown may be added into the card list; the show information of the card to be updated replaces the show information of the corresponding card in the old interaction function version in the smart TV; and then, the APK documents of at least one off-line card in the local documents and in the local database sqlite, and the show information of the at least one off-line card in the card list may be deleted.

Besides, after the card list is called out, if at least one new card (including the on-line card, and/or card to be updated, and/or off-line card relative to the interaction function version in the smart TV) appear at the server, the at least one new card is not updated after the current startup of the card list, but updated after the next startup of the card list.

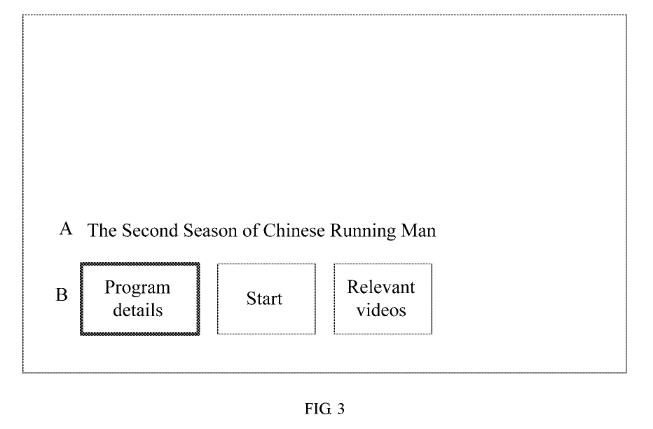

Refer to FIG. 3. According to one embodiment of the present disclosure, when the card list is called out, the title of the current program may be displayed on the first row (row A), and the card name may be displayed on the second row (row B). In addition, when the access to the card is highly correlated to the current program, the card list may show the contents such as photos and texts (for example, poster of the program detail, star, etc.) related to the current program in the card. For example, when the card list shows the high correlated card detail card, the access icon of the program detail card will replace the photo of a specific program in the program detail card. Therefore, when the user uses the interaction functions, the user knows that the interaction functions are all closely related to the current program and obtains better experience.

S27: Show the show information of the at least one card needed to be shown in the card list.

Therefore, the card list may be adapted to different current program modules; in the case of being in different current program modules, the card list may display the show information of the corresponding card according to the current program module.

It is needed to noted that, the card list may include the access to at least one resident card; the resident card may be any one of a program detail card, a star card, a relevant video card and a microblog card, and the program detail card, the star card, the relevant video card and the microblog card are self-defined cards. Wherein, among the self-defined cards, the program detail card, the star card and the relevant video card are installed in the smart TV by default; the background of the smart TV also deems that the program detail card, star card and the relevant video card are in on-line state by default; and in the TV version with the microblog, the access to the microblog card is written in the card list by default. Therefore, the access icons of the program detail card, the star card, the relevant video card and the microblog card certainly appear when the card list is called out, while the access icons of other cards are shown in a dynamic way.

Specifically, according to one embodiment of the present disclosure, the card list is a horizontal list. The horizontal list may be achieved by the component HorizontalListView. The component HorizontalListView is an AdapterView class integrated self-defined component, basically capable of achieving the effect as the same as that of the original Android ListView component, and only different in that the effect of the component of HorizontalListView is a horizontal effect. Wherein the UI of the horizontal list may be shown on the basis of the main Activity of the card list, so the user may operate the card through the card list.

Further, according to one embodiment of the present disclosure, in the process of starting the card list, if at least one new card is an on-line card and/or card to be updated relative to the version of the interaction functions in the smart TV when the server has at least one new card which has passed according to the operation strategies but does not complete installation, then the show information of the at least one new card is not shown after current startup of the card list, but shown after the next startup of the card list.

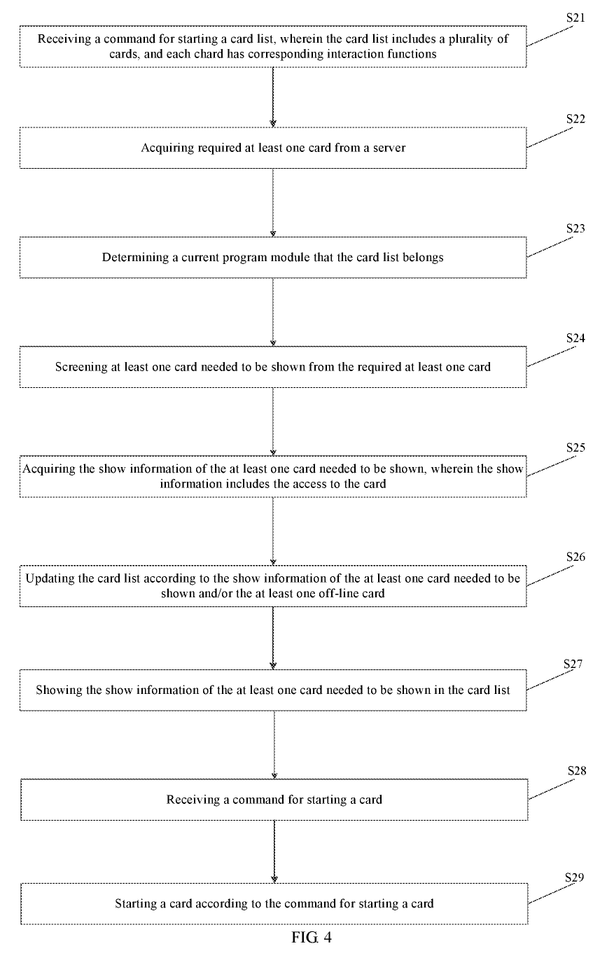

Refer to FIG. 4, which is a step flowchart of card startup of another method for controlling access to interaction functions of a smart TV according to an embodiment of the present disclosure.

Optionally, according to one embodiment of the present disclosure, after the show information of at least one card is shown in the card list, namely after Step 27, the method also includes the following steps.

S28: Receive a command for starting a card.

S29: Start a card according to the command for starting a card.

Specifically, according to one embodiment of the present disclosure, when a user clicks an access icon of a single card in the card list to send a command for starting the card, the command for starting the card triggers an onItemClick event registered in the component HorizontalListView, and the onItemClick event acquires a startup identifier at the same time. Wherein, when the clicked card is a self-defined card, the onItemClick event acquires the main Activity of the card list, the main Activity calls and starts the APK documents of the corresponding card in an agent way through DLPluginManager in an interaction framework (SDK Software Development Kit) of the server corresponding to the smart TV, thus starting the corresponding card. It should be noted that, when the clicked card is a microblog card among the self-defined cards, the onItemClick event skips to the microblog interface. When the clicked card is a third-party card, the onItemClick event acquires the URL address of the card, and the interaction framework SDK of the server corresponding to the third-party card starts the corresponding interface through the URL address.

According to the second embodiment of the present disclosure, after a command for starting a card list is received, required at least one card is acquired from a server, wherein the required at least one card includes new interaction contents issued by the server according to operation strategies; then, the current program module that the card list belongs is determined, wherein the current program module may be any one of a cabled TV module, a carousel module and a request module; after at least one card needed to be shown is selected from the required at least one card, wherein the at least one card needed to be shown may be at least one card, with the card authority applicable to the current program module, among the at least one new on-line card and/or at least one card to be updated, and after the show information (including the access to the card) of the at least one card needed to be shown is acquired, the card list is updated according to the show information of the at least one card need to be shown and/or the at least one off-line card, and finally the show information of the at least one card needed to be shown is shown in the card list. Therefore, according to the operation strategies of the server and the current program module that the card list belongs, the card show information (including the access to the card) may be flexibly configured in real time, new interaction contents may be quickly brought on line, and the current interaction function version may be updated in time, thus greatly improving user experience.

### Embodiment 3

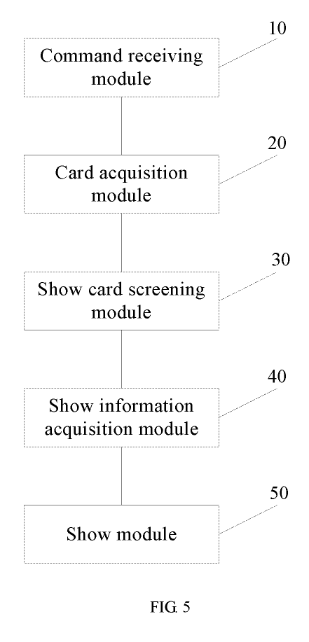

Refer to FIG. 5, which is a structural block diagram of a device for controlling access to interaction functions of a smart TV according to a third embodiment of the present disclosure.

The device for controlling access to interaction functions of a smart TV according to this embodiment of the present disclosure includes:
a command receiving module 10 for receiving a command for starting a card list, wherein the card list includes a plurality of cards, and each card has corresponding interaction function.

Specifically, according one embodiment of the present disclosure, the card is a plugin/APK; the card list is a card APK, and the card APK may be configured as an access to the interaction functions of the card. It should be noted that, the card list may be a card APK of a standard program which conforms to the Android specifications, the main Activity of the card list inherits from DLBasePluginActivity, and the DLBasePluginActivity itself is implemented on the basis of the main Activity of the Android standard application, wherein the main Activity of the card list is agented by the Android dynamic loading framework during operation, while the Android dynamic loading framework may start the card through the main Activity of the card list. Meanwhile, the main Activity of the card list uses the key word “that” when citing resources, instead of the key word “this” as specified by Android. Besides, like the main Activity of the Android standard application, the main Activity of the card list is also a main interface or main window of an application, so the main Activity of the card list may interact with a user.

The device also includes a card acquisition module 20 for acquiring required at least one card from a server.

According to one embodiment of the present disclosure, the required at least one card may include at least one new on-line card, and/or at least one off-line card, and/or at least one card to be updated. This means that, the required at least one card may include at least one new on-line card, or at least one off-line card, or at least one card to be updated, or at least one new on-line card and at least one off-line card, or at least one new on-line card and at least one card to be updated, or at least one off-line card and at least one card to be updated, or at least one new on-line card, at least one off-line card and at least one card to be updated. Therefore, interaction contents with changes relative to the versions of the interaction functions in a smart TV may be acquired from the server.

Specifically, the server may provide the smart TV with an interaction platform server with interaction functions. When the card list is started, the smart TV opens the card acquisition module 20, for example a background Thread, to acquire the required card list from the server and APK documents of each card in the required card list, and stores the required card list and the APK documents of each card in the required card list into a local folder and/or a local database sqlite of the smart TV for later use, for example use when the card list is started later. Optionally, when the required at least one card includes at least one off-line card, the Thread may acquire at least one off-line card list only from the server, and stores the at least one off-line card list into the local folder and/or the local database sqlite of the smart TV for later use.

The device also includes a show card selecting module 30 for selecting at least one card needed to be shown from the required at least one card.

According to one embodiment of the present disclosure, the server may configure the authority to new interaction contents, namely the card authority, according to the operation strategies so each card in the required at least one card has respective authority, and then the show card selecting module 30 may select at least one card needed to be shown according to the respective authority of each card.

The device also includes a show information acquisition module 40 for acquiring the show information of the at least one card needed to be shown, wherein the show information includes the access to the card.

Wherein, according to one embodiment of the present disclosure, the at least one card needed to be shown may include self-defined cards and/or at least one third-party card. Wherein the self-defined cards are self-defined cards of the server, and the third-party card is a card supplied by other interaction platform server. Therefore, the card list may show richer interaction contents.

Optionally, according to one embodiment of the present disclosure, when the card needed to be shown is a self-defined card, acquisition of the show information of the card by the show card acquisition module 40 may be the acquisition of the access (including an access icon) and card name, etc. of the card, when the card needed to be shown in a third-party card, acquisition of the show information of the card by the show card acquisition module 40 may be acquisition of the card access (including the access icon), card name, card's URL address, etc. Wherein the card's URL address may be written at a specific position in the APK document of the card for being read by the card list.

Specifically, after the card acquisition module 20 acquires the APK documents of each card (the APK documents of off-line card excluded) in the required card list, the show information acquisition module 40 may analyze the APK documents of each self-defined card, and the card access, card name, etc. may be acquired through the PackageManager class of Android, while for the third-party card, the show information (access icon, etc.) of the third-party card may be put into the card list in advance. By this time, the show information acquisition module 40 may directly acquire the show information of the third-party card from the card list, without analyzing the APK documents of the third-party card.

It is needed to note that, the access icons of the self-defined cards and the third-party cards may all be visually designed by the server, and packaged and stored in the corresponding APK documents after design. After the card acquisition module 20 acquires the required at least one card from the server, for the self-defined cards, show information acquisition module 40 may take out the access icons of the card through analyzing the APK documents of the self-defined cards; and for the third-party cards, show information acquisition module 40 may directly take out the access icons of the card.

The device also include a show module 50 for showing the show information of the at least one card needed to be shown in the card list.

It is needed to note that, the card list may include the access to at least one resident card; the resident card may be any one of a program detail card, a star card, a relevant video card and a microblog card, and the program detail card, the star card, the relevant video card and the microblog card are self-defined cards. Wherein, among the self-defined cards, the program detail card, the star card and the relevant video card are installed in the smart TV by default; the background of the smart TV also deems that the program detail card, star card and the relevant video card are in on-line state by default; and in the TV version with the microblog, the access to the microblog card is written in the card list by default. Therefore, the access icons of the program detail card, the star card, the relevant video card and the microblog card certainly appear when the card list is called out, while the access icons of other cards are shown in a dynamic way.

Specifically, according to one embodiment of the present disclosure, the card list is a horizontal list. The horizontal list may be achieved by the component HorizontalListView. The component HorizontalListView is an AdapterView class integrated self-defined component, basically capable of achieving the effect as the same as that of the original Android ListView component, and only different in that the effect of the component of HorizontalListView is a horizontal effect. Wherein the UI of the horizontal list may be shown on the basis of the main Activity of the card list, so the user may operate the card through the card list.

Further, according to one embodiment of the present disclosure, in the process of starting the card list, if at least one new card is an on-line card and/or card to be updated relative to the version of the interaction functions in the smart TV when the server has at least one new card which has passed according to the operation strategies but does not complete installation, then the show information of the at least one new card is not shown after current startup of the card list, but shown after the next startup of the card list.

According to the third embodiment of the present disclosure, after the command receiving module receives a command for starting a card list, the card acquisition card acquires required at least one card from a server, wherein the required at least one card includes new interaction contents issued by the server according to operation strategies; then, the show card selecting module selects at least one card needed to be shown from the required at least one card, for example, the show card selecting module selects at least one card select needed to be shown from the required at least one card according to the authority to each card, and after the show information acquisition module acquires the show information (including access to the card) of the at least one card needed to be shown, the show module shows the show information of the at least one card needed to be shown in the card list. Therefore, the card show information (including the access to the card) may be flexibly configured in real time according to the operation strategies of the server, and new interaction contents may be quickly brought on line, thus greatly improving user experience.

### Embodiment 4

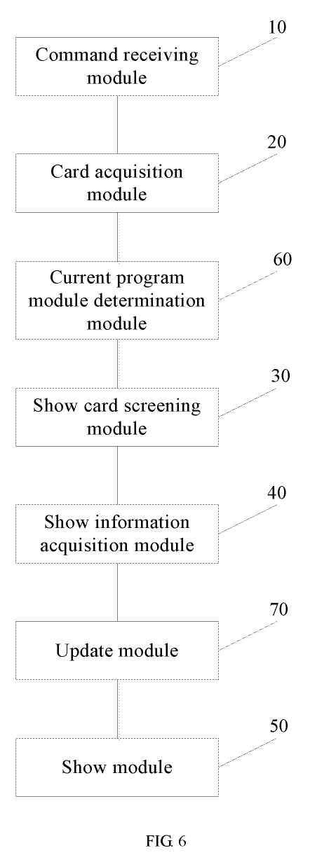

Refer to FIG. 6, which is a structural block diagram of a device for controlling access to interaction functions of a smart TV according to the fourth embodiment of the present disclosure. The device for controlling access to interaction functions of a smart TV may include:
a command receiving module 10 for receiving a command for starting a card list, wherein the card list includes a plurality of cards, and each card has corresponding interaction function.

Specifically, according one embodiment of the present disclosure, the card is a plugin/APK; the card list is a card APK, and the card APK may be configured as an access to the interaction functions of the card. It should be noted that, the card list may be a card APK of a standard program which conforms to the Android specifications; the main Activity of the card list inherits from DLBasePluginActivity, and the DLBasePluginActivity itself is implemented on the basis of the main Activity of the Android standard application, wherein the main Activity of the card list is agented by the Android dynamic loading framework during operation, while the Android dynamic loading framework may start the card through the main Activity of the card list. Meanwhile, the main Activity of the card list uses the key word “that” when citing resources, instead of the key word “this” as specified by Android. Besides, like the main Activity of the Android standard application, the main Activity of the card list is also a main interface or main window of an application, so the main Activity of the card list may interact with a user.

The device also includes a card acquisition module 20 for acquiring required at least one card from a server.

According to one embodiment of the present disclosure, the required at least one card may include at least one new on-line card, and/or at least one off-line card, and/or at least one card to be updated. This means that, the required at least one card may include at least one new on-line card, or at least one off-line card, or at least one card to be updated, or at least one new on-line card and at least one off-line card, or at least one new on-line card and at least one card to be updated, or at least one off-line card and at least one card to be updated, or at least one new on-line card, at least one off-line card and at least one card to be updated. Therefore, the card acquisition module 20 may acquire the interaction contents with changes relative to the versions of the interaction functions in a smart TV from the server in time.

Specifically, the server may provide the smart TV with an interaction platform server with interaction functions. When the card list is started, the smart TV opens the card acquisition module 20, for example a background Thread, to acquire the required card list from the server and APK documents of each card in the required card list, and stores the required card list and the APK documents of each card in the required card list into a local folder and/or a local database sqlite of the smart TV for later use, for example use when the card list is started later. Optionally, when the required at least one card includes at least one off-line card, the Thread may acquire at least one off-line card list only from the server, and stores the at least one off-line card list into the local folder and/or the local database sqlite of the smart TV for later use.

The device also includes a current program module determining module 60 for determining a current program module that the card list belongs.

It should be noted that the current program module determining module 60 may also be disposed between the command receiving module 10 and the card acquisition module 20. The current program module may be any one of a cabled TV module, a carousel module and a request module.

Further, according to one embodiment of the present disclosure, the current program module determining module 60 determines the current program (including the title of the current program) that the card list belongs and determines current program module that the card list belongs at the same time.

The device also includes a show card selecting module 30 for selecting at least one card needed to be shown from the required at least one card.

According to one embodiment of the present disclosure, the server may configure the authority to new interaction contents, namely the card authority, according to the operation strategies so each card in the required at least one card has respective authority, and then the show card selecting module 30 may select at least one card needed to be shown according to the respective authority of each card.

For example, the server may be configured with different cards for different modules according to the operation strategies. It should be noted that, a card may apply to a plurality of modules.

Optionally, according to one embodiment of the present disclosure, the at least one card needed to be shown may be at least one card, with the authority applicable to the current program module, among the at least one new on-line card and/or at least one card to be updated. Therefore, the card list may quickly show new card contents in time.

The device also includes a show information acquisition module 40 for acquiring the show information of the at least one card needed to be shown, wherein the show information includes the access to the card.

Wherein, according to one embodiment of the present disclosure, the at least one card needed to be shown may include self-defined cards and/or at least one third-party card. Wherein the self-defined cards are self-defined cards of the server, and the third-party card is a card supplied by other interaction platform server. Therefore, the card list may show richer interaction contents.

Optionally, according to one embodiment of the present disclosure, when the card needed to be shown is a self-defined card, acquisition of the show information of the card by the show card acquisition module 40 may be the acquisition of the access (including an access icon) and card name, etc. of the card; when the card needed to be shown in a third-party card, acquisition of the show information of the card by the show card acquisition module 40 may be acquisition of the card access (including the access icon), card name, card's URL address, etc. Wherein the card's URL address may be written at a specific position in the APK document of the card for being read by the card list.

Specifically, after the card acquisition module 20 acquires the APK documents of each card (the APK documents of off-line card excluded) in the required card list, the show information acquisition module 40 may analyze the APK documents of each self-defined card, and the card access, card name, etc. may be acquired through the PackageManager class of Android, while for the third-party card, the show information (access icon, etc.) of the third-party card may be put into the card list in advance. By this time, the show information acquisition module 40 may directly acquire the show information of the third-party card from the card list, without analyzing the APK documents of the third-party card.

It is needed to note that, the access icons of the self-defined cards and the third-party cards may all be visually designed by the server, and packaged and stored in the corresponding APK documents after design. After the card acquisition module 20 acquires the required at least one card from the server, for the self-defined cards, show information acquisition module 40 may take out the access icons of the card through analyzing the APK documents of the self-defined cards, and for the third-party cards, show information acquisition module 40 may directly take out the access icons of the card.

The device also includes an update module 70 for updating the card list according to the show information of the at least one card needed to be shown and/or the at least one off-line card.

Wherein, the update module 70 may add the show information of the on-line card among the at least one card needed to be shown into the card list; the show information of the card to be updated replaces the show information of the corresponding card in the old interaction function version in the smart TV; and then, the APK documents of at least one off-line card in the local documents and the APK documents of the at least one off-line card in the local database sqlite, and the show information of the at least one off-line card in the card list may be deleted.

Besides, after the card list is called out, if at least one new card (including the on-line card, and/or card to be updated, and/or off-line card relative to the interaction function version in the smart TV) appear at the server, the update module 70 does not update the at least one new card after the current startup of the card list, but update the at least one new card after the next startup of the card list.

The device also include a show module 50 for showing the show information of the at least one card needed to be shown in the card list.

Therefore, the card list may be adapted to different current program modules; in the case of being in different current program modules, the card list may display the show information of the corresponding card according to the current program module.

It is needed to noted that, the card list may include the access to at least one resident card, the resident card may be any one of a program detail card, a star card, a relevant video card and a microblog card, and the program detail card, the star card, the relevant video card and the microblog card are self-defined cards. Wherein, among the self-defined cards, the program detail card, the star card and the relevant video card are installed in the smart TV by default; the background of the smart TV also deems that the program detail card, star card and the relevant video card are in on-line state by default; and in the TV version with the microblog, the access to the microblog card is written in the card list by default. Therefore, the access icons of the program detail card, the star card, the relevant video card and the microblog card certainly appear when the card list is called out, while the access icons of other cards are shown in a dynamic way.

Specifically, according to one embodiment of the present disclosure, the card list is a horizontal list. The horizontal list may be achieved by the component HorizontalListView. The component HorizontalListView is an AdapterView class integrated self-defined component, basically capable of achieving the effect as the same as that of the original Android ListView component, and only different in that the effect of the component of HorizontalListView is a horizontal effect. Wherein the UI of the horizontal list may be shown on the basis of the main Activity of the card list, so the user may operate the card through the card list.

Further, according to one embodiment of the present disclosure, in the process of starting the card list, if at least one new card is an on-line card and/or card to be updated relative to the version of the interaction functions in the smart TV when the server has at least one new card which has passed according to the operation strategies but does not complete installation, then the show information of the at least one new card is not shown after current startup of the card list, but shown after the next startup of the card list.

Optionally, according to one embodiment of the present disclosure, after the show module 50 shows the show information of at least one card in the card list, the command receiving module 10 may receive the command for starting the card and then start the card according to the command for starting the card.

Specifically, according to one embodiment of the present disclosure, when a user clicks an access icon of a single card in the card list to send a command for starting the card, the command for starting the card triggers the command receiving module 10, for example an onItemClick event registered in the component HorizontalListView, and the onItemClick event acquires a startup identifier at the same time. Wherein, when the clicked card is a self-defined card, the onItemClick event acquires the main Activity of the card list, the main Activity calls and starts the APK documents of the corresponding card in an agent way through DLPluginManager in an interaction framework SDK of the server corresponding to the smart TV, thus starting the corresponding card. It should be noted that, when the clicked card is a microblog card among the self-defined cards, the onItemClick event skips to the microblog interface. When the clicked card is a third-party card, the onItemClick event acquires the URL address of the card, and the interaction framework SDK of the server corresponding to the third-party card starts the corresponding interface through the URL address.

According to the fourth embodiment of the present disclosure, after the command receiving module receives a command for starting a card list, the card acquisition module acquires required at least one card from a server wherein the required at least one card includes new interaction contents issued by the server according to operation strategies; then, the current program module determination module determines the current program module that the card list belongs, wherein the current program module may be any one of a cabled TV module, a carousel module and a request module; after the show card selecting module selects the at least one card needed to be shown from the required at least one card, wherein the at least one card needed to be shown may be at least one card, with the card authority applicable to the current program module, among the at least one new on-line card and/or at least one card to be updated, and after the show information acquisition module acquires the show information (including the access to the card) of the at least one card needed to be shown, the update module updates the card list according to the show information of the at least one card need to be shown and/or the at least one off-line card, and finally the show module shows the show information of the at least one card needed to be shown in the card list. Therefore, according to the operation strategies of the server and the current program module that the card list belongs, the card show information (including the access to the card) may be flexibly configured in real time, new interaction contents may be quickly brought on line, and the current interaction function version may be updated in time, thus greatly improving user experience.

The device embodiment described above is schematic, wherein units described as separable parts may be or may be not physically separated, and components displayed as units may be or may be not physical units, which means that the units may be positioned at one place or distributed on a plurality of network units. Some or all modules may be selected to fulfill the objective of the solution in the embodiment upon actual demands. Those ordinarily skilled in this field may understand and implement the present disclosure without creative work.

Each of devices according to the embodiments of the disclosure may be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

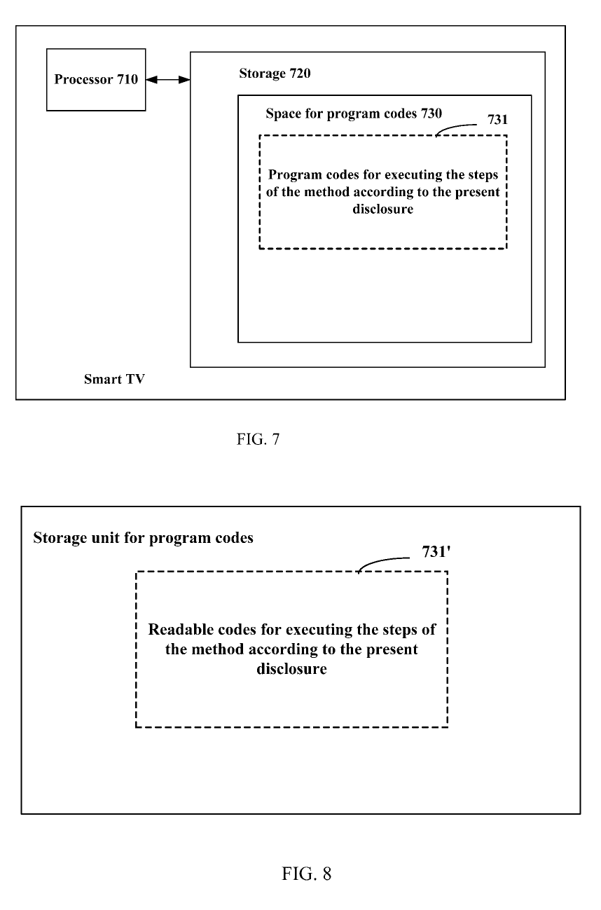

For example, FIG. 7 illustrates a block diagram of an electronic device for executing the method for controlling access to interaction functions according the disclosure. The electronic device may be a smart TV above. Traditionally, the electronic device includes a processor 710 and a computer program product or a computer readable medium in form of a memory 720. The memory 720 could be electronic memories such as flash memory, EEPROM (Electrically Erasable Programmable Read—Only Memory), EPROM, hard disk or ROM. The memory 720 has a memory space 730 for executing program codes 731 of any steps in the above methods. For example, the memory space 730 for program codes may include respective program codes 731 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 8. The memory cells may be provided with memory sections, memory spaces, etc., similar to the memory 720 of the electronic device as shown in FIG. 7. The program codes may be compressed for example in an appropriate form. Usually, the memory cell includes computer readable codes 731, which may be read for example by processors 710. When these codes are operated on the electronic device, the electronic device may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure may be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments may be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings may be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

Through the description of the above embodiments, those skilled in this field may clearly know that the embodiments may be implemented by software and necessary universal hardware platforms, or by hardware. Based on this understanding, the above solutions or contributions thereof to the prior art may be reflected in form of software products, and the computer software products may be stored in computer readable media, for example, ROM/RAM, magnetic discs, optical discs, etc., including various commands, which are used for driving a computer device (which may be a personal computer, a server or a network device) to execute methods described in all embodiments or in some parts of the embodiments.

Finally, it should be noted that the above embodiments are used to describe instead of limiting the technical solution of the present disclosure; although the above embodiments describe the present disclosure in detail, those ordinarily skilled in this field shall understand that they may modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A method for controlling access to interaction functions of a smart TV, comprising:
receiving a command for starting a card list, wherein the card list includes a plurality of cards, and each card has corresponding interaction functions;
acquiring required at least one card from a server;
selecting at least one card needed to be shown from the required at least one card;
acquiring the show information of the at least one card needed to be shown, wherein the show information includes the access to the card; and
showing the show information of the at least one card needed to be shown in the card list.

2. The method according to claim 1, wherein the required at least one card comprises at least one new on-line card, or at least one off-line card, or at least one card to be updated.

3. The method according to claim 2, wherein, before selecting the at least one card needed to be shown from the required at least one card, the method further comprises:
determining a current program module that the card list belongs.

4. The method according to claim 3, wherein, the at least one card needed to be shown is at least one card, applicable to the current program module, among at least one new on-line card or at least one card to be updated.

5. The method according to claim 4, wherein, after acquiring the show information of at least one card needed to be shown and before showing the show information of the at least one card needed to be shown in the card list, the method further comprises:
updating the card list according to the show information of the at least one card needed to be shown or the at least one off-line card.

6. The method according to claim 2, wherein the at least one card needed to be shown comprises self-defined cards and third-party cards.

7. The method according to claim 6, wherein,
when the card needed to be shown is a self-defined card, acquisition of the show information of the card is acquisition of an access to the card and the name of the card,
when the card needed to be shown is a third-party card, acquisition of the show information of the card is acquisition of the access to the card, the name and the URL address of the card.

8. A electronic device for controlling access to interaction functions, comprising:
at least one processor, and
a memory communicably connected with the at least one processor for storing instructions executable by the at least one processor, wherein execution of the instructions by the at least one processor causes the at least one processor to;
receive a command for starting a card list, wherein the card list includes a plurality of cards, and each card has corresponding interaction function;
acquire required at least one card from a server;
elect at least one card needed to be shown from the required at least one card;
acquire the show information of the at least one card needed to be shown, wherein the show information includes the access to the card;
show the show information of the at least one card needed to be shown in the card list.

9. The electronic device according to claim 8, wherein the required at least one card comprises at least one new on-line card, or at least one off-line card, or at least one card to be updated.

10. The electronic device according to claim 9, wherein execution of the instructions by the at least one processor causes the at least one processor to:
determine a current program module that the card list belongs.

11. The electronic device according to claim 10, wherein the at least one card needed to be shown is at least one card, applicable to the current program module, among at least one new on-line card or at least one card to be updated.

12. The electronic device according to claim 11, wherein execution of the instructions by the at least one processor causes the at least one processor to:
update the card list according to the show information of the at least one card needed to be shown or the at least one off-line card.

13. The electronic device according to claim 9, wherein the at least one card needed to be shown comprises self-defined cards and third-party cards.

14. The electronic device according to claim 13, wherein,
when the card needed to be shown is a self-defined card, the acquisition of the show information of the card is acquisition of the access to the card and the name of the card;
and when the card needed to be shown is a third-party card, acquisition of the show information of the card is acquisition of the access to the card, the name and the URL address of the card.

15. A non-transitory computer readable medium storing executable instructions that, when executed by an electronic device, cause the electronic device to:
receive a command for starting a card list, wherein the card list includes a plurality of cards, and each card has corresponding interaction functions;
acquire required at least one card from a server;
select at least one card needed to be shown from the required at least one card;
acquire the show information of the at least one card needed to be shown, wherein the show information includes the access to the card; and
show the show information of the at least one card needed to be shown in the card list.

16. The non-transitory computer readable medium according to claim 15, wherein the required at least one card comprises at least one new on-line card, or at least one off-line card, or at least one card to be updated.

17. The non-transitory computer readable medium according to claim 16, wherein, before select the at least one card needed to be shown from the required at least one card, the electronic device is further caused to:
determine a current program module that the card list belongs.

18. The non-transitory computer readable medium according to claim 17, wherein, the at least one card needed to be shown is at least one card, applicable to the current program module, among at least one new on-line card or at least one card to be updated.

19. The non-transitory computer readable medium according to claim 18, wherein, after acquire the show information of at least one card needed to be shown and before showing the show information of the at least one card needed to be shown in the card list, the electronic device is further caused to:
update the card list according to the show information of the at least one card needed to be shown or the at least one off-line card.

20. The non-transitory computer readable medium according to claim 16, wherein the at least one card needed to be shown comprises self-defined cards and third-party cards.
